(19) United States
(12) Patent Application Publication
(10) Pub. No.: US 2017/0124035 A1
(43) Pub. Date: May 4, 2017

(54) LAYERED USER INTERFACES AND HELP SYSTEMS

(71) Applicant: Ford Global Technologies, LLC, Dearborn, MI (US)

(72) Inventors: Pietro Buttolo, Dearborn Heights, MI (US); James Stewart Rankin, II, Novi, MI (US); Stephen Ronald Tokish, Sylvania, OH (US); Stuart C. Salter, White Lake, MI (US); Yifan Chen, Ann Arbor, MI (US); Gary Steven Strumolo, Canton, MI (US)

(21) Appl. No.: 14/927,947

(22) Filed: Oct. 30, 2015

(51) Int. Cl. G06F 17/22; G09G 5/12; G06F 3/0482; G06F 17/24; G06F 9/44

(52) U.S. Cl. CPC G06F 17/2288; G06F 17/2247; G06F 17/248; G06F 9/4446; G06F 3/0482; G09G 5/12; G09G 2370/022; G09G 2370/027; G09G 2370/06; G09G 2380/10

(57) ABSTRACT

A low-footprint interface template may include identifiers based on an enumeration of characteristics of an in-vehicle component. A rich content interface template may include downloaded content for an in-vehicle component. A rich content user interface may be displayed when a memory includes the rich content interface template and the low-footprint interface template. A low-footprint user interface may be displayed when the memory includes the low-footprint interface template but not the rich content interface template. A user interface interaction to a control of a graphical presentation of the rich content interface template may be detected, and a mapping the interaction to an identifier of a corresponding characteristic of the low-footprint interface template may be performed. The in-vehicle component may be controlled using the identifier of the corresponding characteristic.

### TECHNICAL FIELD

Aspects of the disclosure generally relate to layered user interfaces for device operation and help systems.

### BACKGROUND

Sales of personal devices, such as smartphones and wearables, continue to increase. Thus, more personal devices are brought by users into the automotive context. Smartphones can already be used in some vehicle models to access a wide range of vehicle information, to start the vehicle, and to open windows and doors. Some wearables are capable of providing real-time navigation information to the driver. Device manufacturers are implementing frameworks to enable a more seamless integration of their brand of personal devices into the driving experience.

BLUETOOTH technology may be included in various user devices to allow the devices to communicate with one another. BLUETOOTH low energy (BLE) is another wireless technology designed to provide for communication of data between devices. As compared to BLUETOOTH, BLE offers communication of smaller amounts of data with reduced power consumption. BLE devices may perform the roles of central device or peripheral device. Central devices wirelessly scan for advertisements by peripheral devices, while peripheral devices make the advertisements. Once the peripheral device connects to the central device, the peripheral device may discontinue the advertisement, such that other central devices may no longer be able to wirelessly identify it or connect to it until the existing connection is terminated.

BLE devices transfer data using concepts referred to as services and characteristics. Services are collections of characteristics. A central device may connect to and access one or more of the characteristics of a service of a peripheral device. Characteristics encapsulate a single value or data type having one or more bytes of data as well as zero or more descriptors that describe the value of the characteristic. The descriptors may include information such as human-readable descriptions, a range for the value of the characteristic, or a unit of measure of the value of the characteristics. A Service Discovery Protocol (SDP) may allow a device to discover services offered by other devices and their associated parameters. The services may be identified by universally unique identifiers (UUIDs).

### SUMMARY

In a first illustrative embodiment, a system includes a memory; a display; and a processor, programmed to provide, to the display, a rich content user interface when the memory includes, for an in-vehicle component, a rich content interface template including downloaded media content and a low-footprint interface template generated from feature advertisements of the in-vehicle component; and provide, to the display, a low-footprint user interface when the memory includes the low-footprint interface template but not the rich content interface template.

In a second illustrative embodiment, a method includes maintaining a rich content interface template including downloaded content for an in-vehicle component; maintaining a low-footprint interface template including identifiers based on an enumeration of characteristics of the in-vehicle component; detecting a user interface interaction to a control of a graphical presentation of the rich content interface template; mapping the interaction to an identifier of a corresponding characteristic of the low-footprint interface template; and controlling the in-vehicle component using the identifier.

In a third illustrative embodiment, a non-transitory computer-readable medium embodying instructions that, when executed by a processor of a personal device, cause the personal device to enumerate characteristics of one or more services indicating features of an in-vehicle component; generate a low-footprint interface template based on the characteristics; display a low-footprint user interface using the low-footprint interface template; download a rich content interface template for the in-vehicle component; and switch to displaying a rich content user interface using on the rich content interface template responsive to completion of the download of the rich content interface template.

### BRIEF DESCRIPTION OF THE DRAWINGS

FIG. 1A illustrates an example system including a vehicle having a mesh of in-vehicle components configured to locate and interact with users and personal devices of the users;

FIG. 1B illustrates an example in-vehicle component equipped with a wireless transceiver configured to facilitate detection of and identify proximity of the personal devices;

FIG. 1C illustrates an example in-vehicle component requesting signal strength from other in-vehicle components of the vehicle;

FIG. 2 illustrates an example information exchange flow between the personal device and the in-vehicle components of the vehicle;

FIG. 3 illustrates an example user interface derived from a low-footprint content interface template;

FIG. 4 illustrates an example user interface derived from a rich content interface template;

FIG. 5 illustrates an example mapping of the controls of the graphical presentation to the controls of the list presentation;

FIG. 6 illustrates an example process for rendering a user interface for control of an in-vehicle component;

FIG. 7 illustrates an example process for providing interface template information by an in-vehicle component;

FIG. 8 illustrates an example help user interface derived from a low-footprint interface template; and

FIG. 9 illustrates an example help user interface derived from a rich content interface template.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle interior modules, such as reading lights or speakers, may be enhanced with a wireless communication interface such as Bluetooth Low Energy (BLE). These enhanced modules of the vehicle interior may be referred to as in-vehicle components. Vehicle occupants may utilize their personal devices to control features of the in-vehicle components over the communications interface. In an example, a vehicle occupant may utilize an application installed to the personal device to turn a reading light on or off or to adjust a volume of a speaker.

The personal device may display an interface to facilitate user interaction with the in-vehicle component. This user interface may display options available to configure the in-vehicle component, as well as status information indicating the current configuration of the in-vehicle component. The user interface may additionally or alternately display help features descriptive of the functionality of the in-vehicle component.

A simple version of the user interface may be generated based on a basic low-footprint interface template that is easily transferred to the personal device. The low-footprint interface template may include information embedded in Bluetooth protocol universally-unique identifiers (UUIDs) that are exchanged between the in-vehicle component and the personal device. For example, information indicative of the available features and their statuses may be encoded in characteristic UUIDs of one or more services advertised by the in-vehicle component. This advertised information may be used by the personal device to programmatically generate a graphical listing of available features and their current statuses.

A more content-rich and user-friendly version of the user interface may be generated based on a rich content interface template. The rich content interface template may include interface markup language with media content information, such as graphics illustrating the in-vehicle component, sounds, haptic effects, control locations, and other details of the user interface. The rich content interface template may be downloaded to the personal device from the in-vehicle component. As some other possibilities, the rich content interface template may be downloaded from another component of the vehicle configured to facilitate dissemination of the rich content interface template, or from a server external to the vehicle.

As the rich content interface template includes a greater amount of content than the low-footprint interface template, the rich content interface template may take more time to receive than the basic interface template. Accordingly, the personal device may display the user interface based on the low-footprint interface template initially, and may switch to the rich content interface template once the rich content interface template is downloaded and available for use.

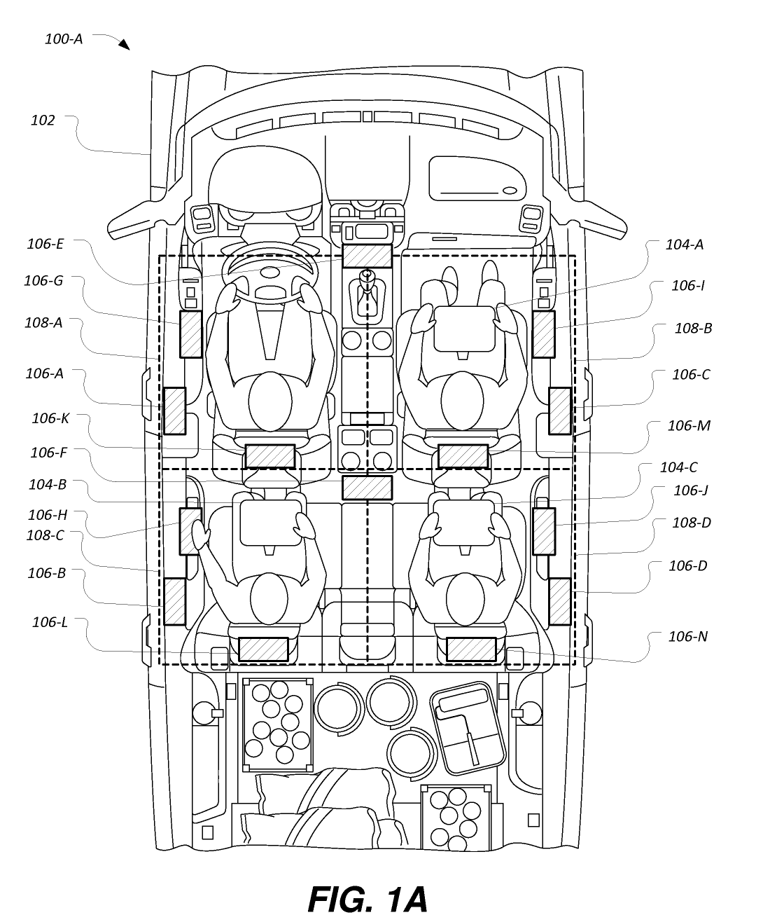

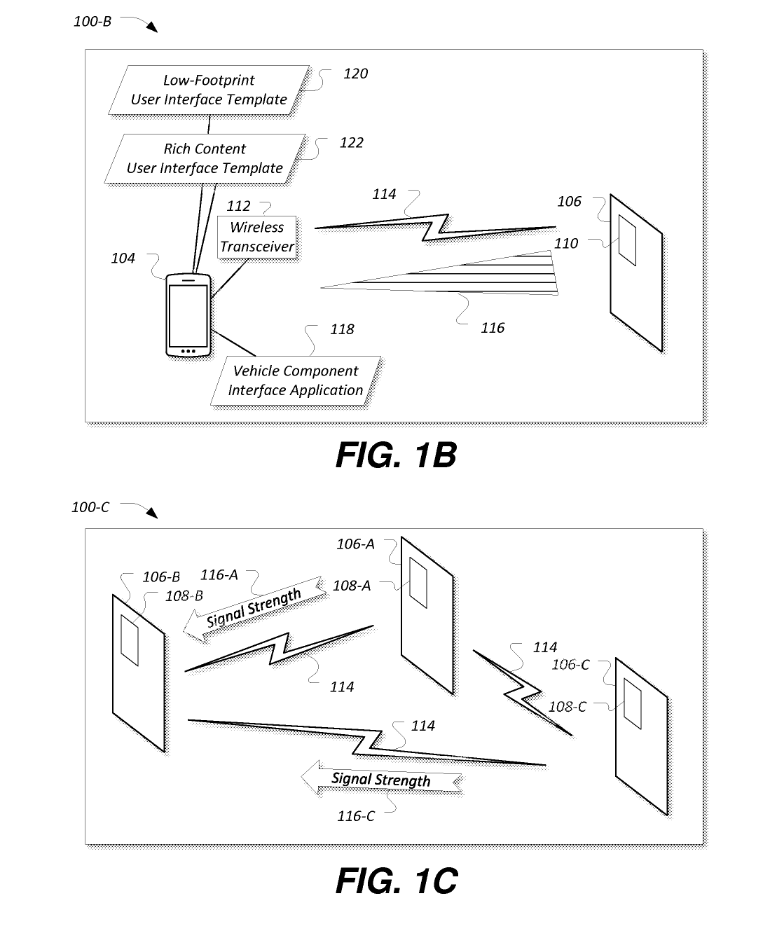

FIG. 1A illustrates an example system 100 including a vehicle 102 having a mesh of in-vehicle components 106 configured to locate and interact with users and personal devices 104 of the users. The system 100 may be configured to allow the users, such as vehicle occupants, to seamlessly interact with the in-vehicle components 106 in the vehicle 102 or with any other framework-enabled vehicle 102. Moreover, the interaction may be performed without requiring the personal devices 104 to have been paired with or be in communication with a head unit or other centralized computing platform of the vehicle 102.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The personal devices 104-A, 104-B and 104-C (collectively 104) may include mobile devices of the users, and/or wearable devices of the users. The mobile devices may be any of various types of portable computing device, such as cellular phones, tablet computers, smart watches, laptop computers, portable music players, or other devices capable of user interface display and networked communication with other mobile devices. The wearable devices may include, as some non-limiting examples, smartwatches, smart glasses, fitness bands, control rings, or other personal mobility or accessory device designed to be worn and to communicate with the user's mobile device.

The in-vehicle components 106-A through 106-N (collectively 106) may include various elements of the vehicle 102 having user-configurable settings. These in-vehicle components 106 may include, as some examples, overhead light in-vehicle components 106-A through 106-D, climate control in-vehicle components 106-E and 106-F, seat control in-vehicle components 106-G through 106-J, and speaker in-vehicle components 106-K through 106-N. Other examples of in-vehicle components 106 are possible as well, such as rear seat entertainment screens or automated window shades. In many cases, the in-vehicle component 106 may expose controls such as buttons, sliders, and touchscreens that may be used by the user to configure the particular settings of the in-vehicle component 106. As some possibilities, the controls of the in-vehicle component 106 may allow the user to set a lighting level of a light control, set a temperature of a climate control, set a volume and source of audio for a speaker, and set a position of a seat.

The vehicle 102 interior may be divided into multiple zones 108, where each zone 108 may be associated with a seating position within the vehicle 102 interior. For instance, the front row of the illustrated vehicle 102 may include a first zone 108-A associated with the driver seating position, and a second zone 108-B associated with a front passenger seating position. The second row of the illustrated vehicle 102 may include a third zone 108-C associated with a driver-side rear seating position and a fourth zone 108-D associated with a passenger-side rear seating position. Variations on the number and arrangement of zones 108 are possible. For instance, an alternate second row may include an additional fifth zone 108 of a second-row middle seating position (not shown). Four occupants are illustrated as being inside the example vehicle 102, three of whom are using personal devices 104. A driver occupant in the zone 108-A is not using a personal device 104. A front passenger occupant in the zone 108-B is using the personal device 104-A. A rear driver-side passenger occupant in the zone 108-C is using the personal device 104-B. A rear passenger-side passenger occupant in the zone 108-D is using the personal device 104-C.

Each of the various in-vehicle components 106 present in the vehicle 102 interior may be associated with the one or more of the zones 108. As some examples, the in-vehicle components 106 may be associated with the zone 108 in which the respective in-vehicle component 106 is located and/or the one (or more) of the zones 108 that is controlled by the respective in-vehicle component 106. For instance, the light in-vehicle component 106-C accessible by the front passenger may be associated with the second zone 108-B, while the light in-vehicle component 106-D accessible by passenger-side rear may be associated with the fourth zone 108-D. It should be noted that the illustrated portion of the vehicle 102 in FIG. 1A is merely an example, and more, fewer, and/or differently located in-vehicle components 106 and zones 108 may be used.

Referring to FIG. 1B, each in-vehicle component 106 may be equipped with a wireless transceiver 110 configured to facilitate detection of and identify proximity of the personal devices 104. In an example, the wireless transceiver 110 may include a wireless device, such as a Bluetooth Low Energy transceiver configured to enable low energy Bluetooth signal intensity as a locator, to determine the proximity of the personal devices 104. Detection of proximity of the personal device 104 by the wireless transceiver 110 may, in an example, cause a vehicle component interface application 118 of the detected personal device 104 to be activated.

In many examples the personal devices 104 may include a wireless transceiver 112 (e.g., a BLUETOOTH module, a ZIGBEE transceiver, a Wi-Fi transceiver, an IrDA transceiver, an RFID transceiver, etc.) configured to communicate with other compatible devices. In an example, the wireless transceiver 112 of the personal device 104 may communicate data with the wireless transceiver 110 of the in-vehicle component 106 over a wireless connection 114. In another example, a wireless transceiver 112 of a wearable personal device 104 may communicate data with a wireless transceiver 112 of a mobile personal device 104 over a wireless connection 114. The wireless connections 114 may be a Bluetooth Low Energy (BLE) connection, but other types of local wireless connection 114, such as Wi-Fi or Zigbee may be utilized as well.

The personal devices 104 may also include a device modem configured to facilitate communication of the personal devices 104 with other devices over a communications network. The communications network may provide communications services, such as packet-switched network services (e.g., Internet access, voice over internet protocol (VoIP) communication services), to devices connected to the communications network. An example of a communications network may include a cellular telephone network. To facilitate the communications over the communications network, personal devices 104 may be associated with unique device identifiers (e.g., mobile device numbers (MDNs), Internet protocol (IP) addresses, identifiers of the device modems, etc.) to identify the communications of the personal devices 104 over the communications network. These personal device 104 identifiers may also be utilized by the in-vehicle component 106 to identify the personal devices 104.

The vehicle component interface application 118 may be an application installed to the personal device 104. The vehicle component interface application 118 may be configured to facilitate vehicle occupant access to features of the in-vehicle components 106 exposed for networked configuration via the wireless transceiver 110. In some cases, the vehicle component interface application 118 may be configured to identify the available in-vehicle components 106, identify the available features and current settings of the identified in-vehicle components 106, and determine which of the available in-vehicle components 106 are within proximity to the vehicle occupant (e.g., in the same zone 108 as the location of the personal device 104).

The vehicle component interface application 118 may be further configured to display a user interface descriptive of the available features, receive user input, and provide commands based on the user input to allow the user to manipulate or control the features of the in-vehicle components 106. Thus, the system 100 may be configured to allow vehicle occupants to seamlessly interact with the in-vehicle components 106 in the vehicle 102, without requiring the personal devices 104 to have been paired with or be in communication with a head unit of the vehicle 102.

The system 100 may use one or more device location-tracking techniques to identify the zone 108 in which the personal device 104 is located. Location-tracking techniques may be classified depending on whether the estimate is based on proximity, angulation or lateration. Proximity methods are “coarse-grained,” and may provide information regarding whether a target is within a predefined range but they do not provide an exact location of the target. Angulation methods estimate a position of the target according to angles between the target and reference locations. Lateration provide an estimate of the target location, starting from available distances between target and references. The distance of the target from a reference can be obtained from a measurement of signal strength 116 over the wireless connection 114 between the wireless transceiver 110 of the in-vehicle component 106 and the wireless transceiver 112 of the personal device 104, or from a time measurement of either arrival (TOA) or difference of arrival (TDOA).

One of the advantages of lateration using signal strength 116 is that it can leverage the already-existing received signal strength indication (RSSI) signal strength 116 information available in many communication protocols. For example, iBeacon uses the RSSI signal strength 116 information available in the Bluetooth Low-Energy (BLE) protocol to infer the distance of a beacon from a personal device 104 (i.e. a target), so that specific events can be triggered as the personal device 104 approaches the beacon. Other implementations expand on the concept, leveraging multiple references to estimate the location of the target. When the distance from three reference beacons are known, the location can be estimated in full (trilateration) from the following equations:

d₁²=(x−x₁)² +(y−y₁)²+(z−z₁)²

d₂²=(x−x₂)² +(y−y₂)²+(z−z₂)²

d₃²=(x−x₃)² +(y−y₃)²+(z−z₃)² (1)

In an example, as shown in FIG. 1C, an in-vehicle component 106-B may broadcast or otherwise send a request for signal strength 116 to other in-vehicle components 106-A and 106-C of the vehicle 102. This request may cause the other in-vehicle components 106-A and 106-C to return wireless signal strength 116 data identified by their respective wireless transceiver 110 for whatever devices they detect (e.g., signal strength 116-A for the personal device 104 identified by the wireless transceiver 110-A, signal strength 116-C for the personal device 104 identified by the wireless transceiver 110-C). Using these signal strengths 116-A and 116-C, as well as signal strength 116-B determined by the in-vehicle component 106-B using its wireless transceiver 110-B, the in-vehicle component 106-B may use the equations (1) to perform trilateration and locate the personal device 104. As another possibility, the in-vehicle component 106 may identify the personal device 104 with the highest signal strength 116 at the in-vehicle component 106 as being the personal device 104 within the zone 108 as follows:

$$Personal Device = i ⇒ {max}_{i = 1 , n} {RSSI}_{i} \qquad ( 2 )$$

Thus, the mesh of in-vehicle components 106 and the personal devices 104 may accordingly be utilized to allow the in-vehicle components 106 to identify in which zone 108 each personal device 104 is located.

To enable tracking of personal devices 104 within the vehicle 102, information descriptive of the location (e.g., zone 108) of each in-vehicle component 106 relative to the vehicle 102 interior may be advertised or broadcast by the in-vehicle components 106 to the other in-vehicle components 106 and personal devices 104. Moreover, to provide status information indicative of the current settings of the in-vehicle components 106, the in-vehicle components 106 may also advertised or broadcast status information and/or information indicative of when changes to the settings of the in-vehicle components 106 are made.

The vehicle component interface application 118 executed by the personal device 104 may be configured to scan for and update a data store of available in-vehicle components 106. As some examples, the scanning may be performed periodically, responsive to a user request to refresh, or upon activation of the vehicle component interface application 118. In examples where the scanning is performed automatically, the transition from vehicle 102 to vehicle 102 may be seamless, as the correct set of functionality is continuously refreshed and the user interface of the vehicle component interface application 118 is updated to reflect the changes.

BLE advertising packets in broadcasting mode may be used to communicate location, event, or other information from the in-vehicle components 106 to the personal devices 104. This may be advantageous, as the personal devices 104 may be unable to preemptively connect to each of the in-vehicle components 106 to receive status updates. In many BLE implementations, there is a maximum count of BLE connections that may be maintained, and the number of in-vehicle components 106 may exceed this amount. Moreover, many BLE implementations either do not allow for the advertisement of user data, or if such advertisement is provided, use different or incompatible data types to advertise it. However, location and event information may be embedded into the primary service UUID that is included in the advertisement packet made by the in-vehicle component 106.

In an example, the advertised information may include information packed into the primary service UUID for the in-vehicle component 106. This information may include a predefined prefix value or other identifier indicating that the advertisement is for an in-vehicle component 106. The advertisement may also include other information, such as location, component type, and event information (e.g., a counter that changes to inform a listener that the status of the component had changed and should be re-read). By parsing the service UUIDs of the advertisement data of the in-vehicle component 106, personal devices 104 and other in-vehicle components 106 scanning for advertisements may be able to: (i) identify the existence in the vehicle 102 of the in-vehicle component 106, (ii) determine its location and zone 108 within the vehicle 102, and (iii) detect whether a physical interaction has taken place between a user and the in-vehicle component 106 (e.g., when changes are identified to the advertised data).

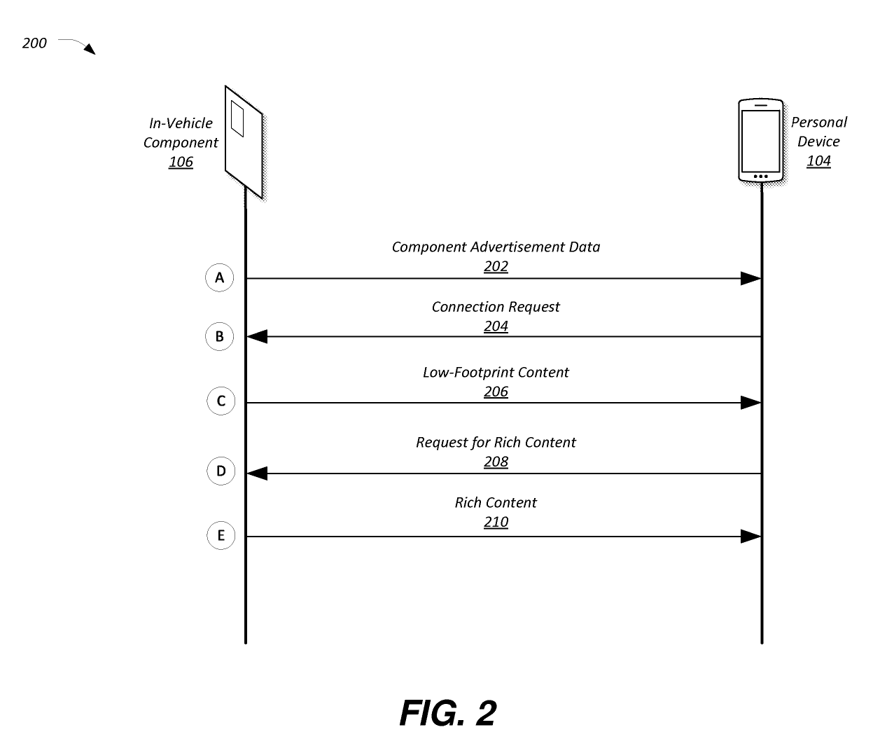

FIG. 2 illustrates an example information exchange flow 200 between the personal device 104 and the in-vehicle components 106 of the vehicle 102. With reference to the examples of FIG. 1A, four passengers are shown as sharing a ride in the vehicle 102. The passengers may have entered the vehicle 102 carrying their personal devices 104. For sake of explanation, the example information exchange flow 200 may be performed between those personal devices 104 and in-vehicle components 106.

As shown in the information exchange flow 200, as the devices 104 settle into their respective seating location zones 108, at time index (A) the personal devices 104 may collect the advertisement data 202 information from the in-vehicle components 106 to identify what in-vehicle components 106 are located in the zones 108 of the passengers and what functionality is provided. The advertisement data 202 may include information indicative of the functionality of the in-vehicle components 106, of the locations or seating zones 108 of the in-vehicle components 106, and an optional identifier indicating that the in-vehicle component 106 supports providing a rich user interface.

As each personal device 104 scans the advertisement data 202, if an identifier indicating that the advertisement is for an in-vehicle component 106 in the same zone as the personal device 104 is found, a connection request 204 may be sent to the service identifier UUID of the in-vehicle component 106 as shown at time index (B).

Low-footprint content 210 embedded in the Bluetooth protocol UUIDs may be received by the personal device 104 at time index (C). The retrieval of the low-footprint content 210 may be responsive to a request from the user to configure the in-vehicle component 106 (e.g., via the vehicle component interface application 118, via user interaction with the controls of the in-vehicle component 106, etc.).

In an example, the low-footprint content 210 may retrieved by the personal device 104 and compiled into a low-footprint content interface template 120 for the in-vehicle component 106. The low-footprint content 210 may be specified by characteristic UUIDs of the characteristics of the service UUID of the in-vehicle component 106. The minimal definition of the low-footprint content interface template 120 may include, for example, information decoded from the characteristic UUIDs, such as a listing of names and/or identifiers of the available features of the in-vehicle component 106 and/or information indicative of the current state of the in-vehicle component 106. The personal device 104 may store the low-footprint content interface template 120 to a memory of the personal device 104, to allow for the low-footprint content interface template 120 to be available for later use. In an example, the low-footprint content interface template 120 may be indexed in the memory according to service identifier of the in-vehicle component 106 to facilitate its identification and retrieval.

If the optional identifier indicates that the in-vehicle component 106 supports providing a rich user interface, at time index (D) the personal device 104 sends a request to the in-vehicle component 106 for the in-vehicle component 106 to communicate its rich content interface template 122 to the personal device 104. The rich content interface template 122 may include interface markup language, such as HyperText Markup Language (HTML), Extensible Hypertext Markup Language (XHTML), Scalable Vector Graphics (SVG), Extensible Application Markup Language (XAML), as some non-limiting examples, as well as additional media content references by the markup language that may be used to generate the user interface, such as graphics, sound, and indications of haptic effects, as some non-limiting examples. Thus, the rich content interface template 122 may define a presentation of content including media content and selectable controls that, when invoked, request that various functions of the in-vehicle component 106 be performed. In some cases, personal device 104 may be further configured to delay a predetermined amount of time to allow other personal devices 104 within the vehicle 102 to complete the initial transfer of user interface information from the in-vehicle component 106 before sending the request for the rich content interface template 122.

At time index (E), the personal device 104 may begin receiving the rich content interface template 122 from the in-vehicle component 106. The rich content interface template 122 may be saved on permanent storage of the personal device 104. In an example, the rich content interface template 122 may be indexed in the memory according to service identifier of the in-vehicle component 106 to facilitate its identification and retrieval. Thus, if the personal device 104 later identifies an advertisement for an in-vehicle component 106 with the same service identifier in the same or a different vehicle 102, the rich content interface template 122 (and/or low-footprint content interface template 120) may be directly and quickly acquired from the storage of the personal device 104.

Notably, because of the potential large number of personal devices 104 present in the vehicle 102, it might take some time before the rich content interface template 122 is fully available for use in generation of a user interface by the personal device 104. However, as the low-footprint content 210 may be compiled based on an enumeration of the characteristics exposed by the in-vehicle component 106, the low-footprint content interface template 120 may quickly be retrieved. Accordingly, the low-footprint content interface template 120 may allow for presentation of a user interface in the event the passenger intends to interact with some interior feature before the rich content interface template 122 has been fully retrieved. Therefore, when a passenger, for example someone located in the rear driver-side zone 108-C as shown in FIG. 1A, reaches for an in-vehicle component 106, or initiates otherwise interaction with it, the best interface template available to the personal device 104 may be used to facilitate the user interaction with the in-vehicle component 106.

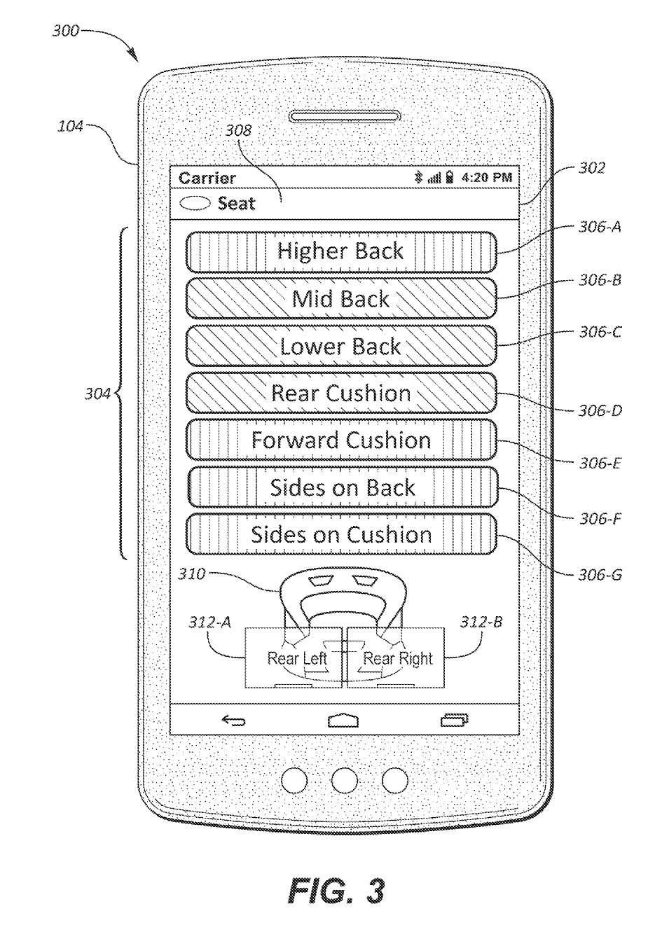

FIG. 3 illustrates an example user interface 300 derived from a low-footprint content interface template 120. For example, the user interface 300 includes information related to features of a seat in-vehicle component 106. The user interface 300 may be generated by the vehicle component interface application 118 based on the information collected from the characteristics of the service of the in-vehicle component 106, and may be provided to the display 302 of the personal device 104. The user interface 300 may include a presentation 304 configured to display selectable controls 306 based on the identified in-vehicle components 106 features. Each of the selectable controls 306 (e.g., 306-A through 306-G in the illustrated example) may indicate a function of the indicated in-vehicle component 106 that is available for configuration by the user. For example, each enumerated characteristic of the services of the in-vehicle component 106 may be represented in the presentation 304 as a separate selectable control 306. The user interface 300 may also include a title label 308 to indicate to the user that the user interface 300 is displaying a menu of functions of the indicated in-vehicle component 106 (e.g., a seat as shown).

As illustrated, the presentation 304 is a listing includes a control 306-A for toggling on and off a massage function of the higher back of the seat in-vehicle component 106, a control 304-B for toggling on and off a function of the middle back of the seat in-vehicle component 106, a control 304-C for toggling on and off a function of the lower back of the seat in-vehicle component 106, a control 304-D for toggling on and off a function of the rear cushion of the seat in-vehicle component 106, a control 304-E for toggling on and off a function of the forward cushion of the seat in-vehicle component 106, a control 304-F for toggling on and off a function of the back bolsters of the seat in-vehicle component 106, and a control 304-G for toggling on and off a function of the cushion bolsters of the seat in-vehicle component 106. The presentation 304 may further indicate the current statuses of the enumerated characteristics. For instance, characteristics that indicate functions that are active may be indicated in an active state (e.g., in a first color, with a selected checkbox, in highlight, etc.), while characteristics that indicate functions that are not active may be indicated in an inactive state (e.g., in a second color different from the first color, with an unselected checkbox, not in highlight, etc.).

The listing 304 may also provide for scrolling in cases where there are more controls 304 that may be visually represented in the display 302 at one time. In some cases, the controls 306 may be displayed on a touch screen such that the user may be able to touch the controls 306 to make adjustments to the functions of the in-vehicle component 106. As another example, the user interface 300 may support voice commands. For example, to toggle the higher back function, the user may speak the voice command “HIGHER BACK.” It should be noted that the illustrated presentation 304 and controls 306 are merely examples, and more or different functions or presentations 304 of the functions of the in-vehicle component 106 may be utilized.

In some examples, the user interface 300 may further include a zone interface 310 to select additional in-vehicle components 106 that are available inside the vehicle 102 within different zones 108. As one possibility, the zone interface 310 may include a control 312-A for selection of a driver-side rear zone 108-C, and a control 312-B for selection of a passenger-side rear zone 108-D (collectively controls 312). Responsive to selection of one of the controls 312, the user interface 300 may accordingly display the controls 304 of corresponding in-vehicle component 106 for the selected zone 108. For instance, if the seat controls in the zone 108-C is currently being displayed and the user selects the control 312-B to display the corresponding seat controls for the zone 108-D, the user interface 300 may display the functions of the seat control for the zone 108-D.

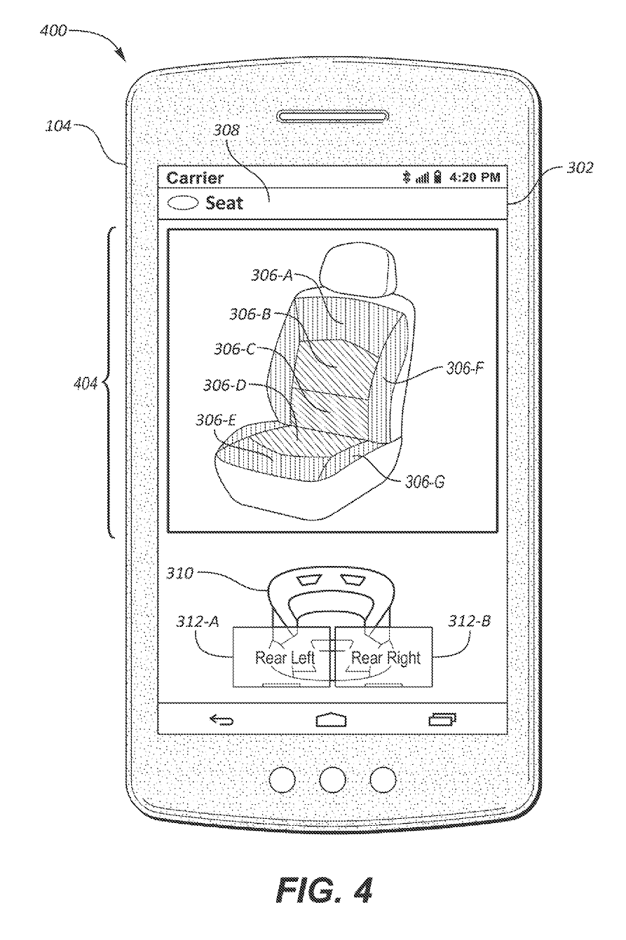

FIG. 4 illustrates an example user interface 400 derived from a rich content interface template 122. The user interface 400 includes information related to the same features of the seat in-vehicle component 106 included in the user interface 300. However, the rich content interface template 122 includes additional content that, as shown, may be used to generate a more engaging user interface 400. For instance, the rich content interface template 122 may include eXtensible Markup Language (XML), JavaScript Object Notation (JSON), Hypertext Markup Language (HTML) such as HTML 5 or XHTML, and/or another markup format for describing the user interface 400, as well as media such as graphics and sounds references by the rich content interface template 122. The rich content interface template 122 may further indicate locations on the screen and/or types of controls to be rendered on the screen to display the functions and statuses of the functions in-vehicle component 106. As one possibility, the rich content interface template 122 may include a web content version of the user interface 400 to be rendered by a web browser, where the web content includes links that, when, selected, indicate requests to invoke various features of the in-vehicle component 106.

For sake of explanation, as compared to the example user interface 300 which displays a listing-style presentation 304 of the controls 306, the example user interface 400 instead displays a graphical image of the seat itself in a graphical presentation 404 of the controls 306.

Notably, the same set of functionality (e.g., the controls 306-A through 306-G) is available in the user interface 400. Thus, as compared to the listing in the user interface 300, the user interface 400 illustrates the functions of the in-vehicle component 106 at the locations of the in-vehicle component 106 to which they relate.

While the user interface 300 and user interface 400 may display the same features differently, the interaction between the personal device 104 and the in-vehicle component 106 to be controlled may be handled similarly. For instance, as the user manipulates a control on the example user interface 400, an identifier of the feature to be controlled from the rich content interface template 122 is matched to a control identifier of the low-footprint content interface template 120.

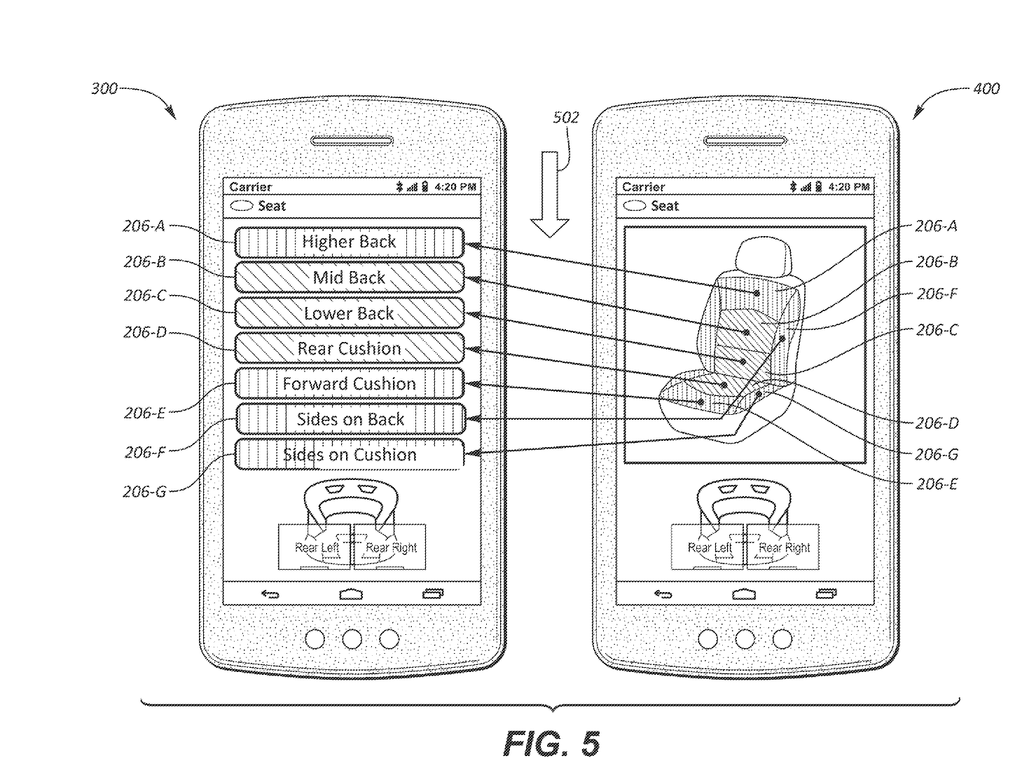

FIG. 5 illustrates an example mapping 502 of the controls 306 of the graphical presentation 404 to the controls 306 of the list presentation 304. The low-footprint content interface template 120 may then be used to communicate the desired interaction to the in-vehicle component 106. Thus, regardless of which user interface 300 or 400 is used, the interaction with the in-vehicle component 106 may be performed with a relatively low footprint.

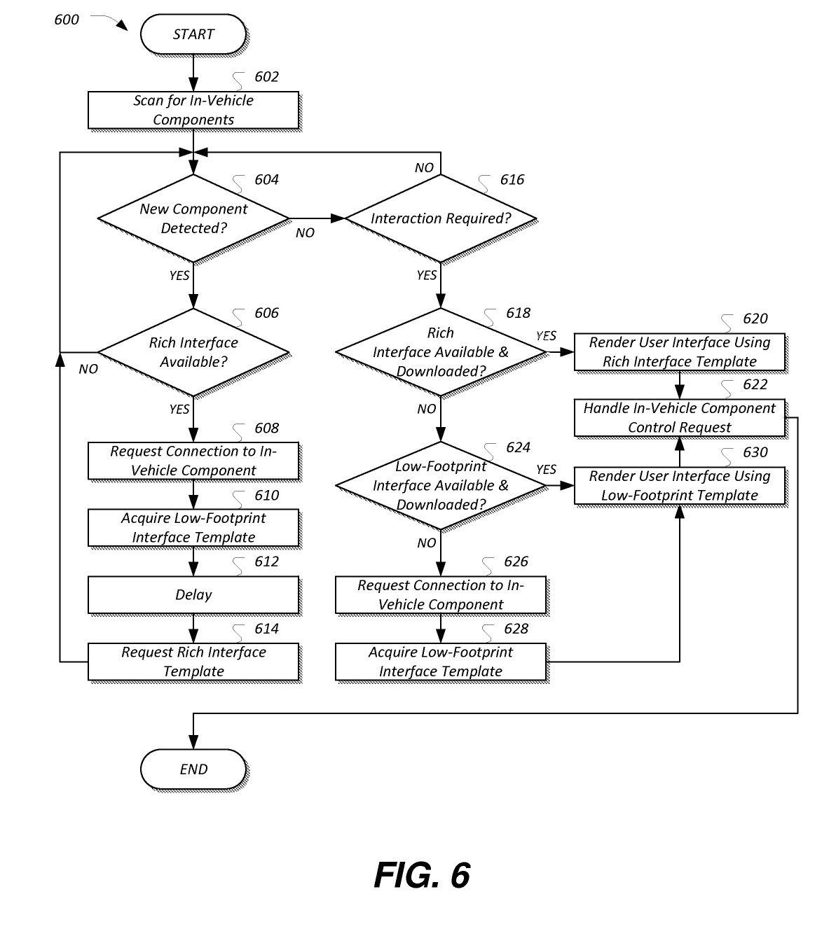

FIG. 6 illustrates an example process 600 for rendering a user interface for control of an in-vehicle component 106. The process 600 may begin at operation 602, in which the personal device 104 may scan for in-vehicle components 106. In an example, a scanning service of the vehicle component interface application 118 executed by the personal device 104 may utilize the wireless transceiver 112 to scan for BLE advertisements.

At operation 604, the personal device 104 determines whether the detected in-vehicle component 106 is newly detected. For instance, the personal device 104 may maintain data indicative of the located in-vehicle components 106. The personal device 104 may compare elements of the service identifier of the detected in-vehicle component 106 (e.g., location, zone, type, etc.) to the corresponding elements of the service identifiers of the previously-detected in-vehicle components 106 to determine whether the in-vehicle component 106 was newly detected. If the in-vehicle component 106 is newly detected, control passes to operation 606. Otherwise, control passes to operation 616.

At 606, the personal device 104 determines whether a rich content interface template 122 is enabled for the in-vehicle component 106. For example, the vehicle component interface application 118 may determine whether the optional identifier of the service identifier UUID of the in-vehicle component 106 specifies that the in-vehicle component 106 supports providing a rich user interface. If so, control passes to operation 608. Otherwise control passes to operation 604.

The personal device 104 requests connection to the in-vehicle component 106 at operation 608. As an example, the vehicle component interface application 118 may send request to connect to the service identifier UUID of the in-vehicle component 106. At operation 610, the personal device 104 acquires the low-footprint interface template 120. For instance, the vehicle component interface application 118 may utilize the wireless transceiver 112 to enumerate the characteristic advertisements for the service(s) of the in-vehicle component 106.

At operation 612, the personal device 104 may optionally delay before attempting to retrieve the rich content interface template 122. In an example, the vehicle component interface application 118 may delay a predetermined amount of time from connection to the in-vehicle component 106, such as using a predetermined wait value stored to the storage of the personal device 104.

At 614, the personal device 104 requests the rich content interface template 122. As one example, the vehicle component interface application 118 may sends a request to the in-vehicle component 106 for the in-vehicle component 106 to communicate the rich content interface template 122 to the personal device 104. As another example, the vehicle component interface application 118 may request the rich content interface template 122 from a server component within the vehicle 102 programmed to provide rich content interface templates 122. As yet another example, the vehicle component interface application 118 may request the rich content interface template 122 from a server external to the vehicle 102 by specifying the service identifier of the in-vehicle component 106 to the server. After operation 614, the process 600 continues to operation 604.

At operation 616, the personal device 104 determines whether interaction with the in-vehicle component 106 is requested by a user of the personal device 104. For example, the user may decide to manipulate or control the in-vehicle component 106, e.g., by selecting to do so from a user interface provided by the vehicle component interface application 118, or because the in-vehicle component 106 advertised or otherwise indicated to the personal device 104 that it was triggered by a physical interaction on the in-vehicle component 106.

At 618, the personal device 104 determines whether the rich content interface template 122 is available. For example, the vehicle component interface application 118 may access the storage of the personal device 104 to determine if a rich content interface template 122 associated with the service identifier UUID of the in-vehicle component 106 is available. If so, control passes to operation 620. If not, control passes to operation 624.

The personal device 104 provides the user interface 400 derived from a rich content interface template 122 at operation 620. An example user interface 400 is described above with respect to FIG. 4.

At operation 622, the personal device 104 handles an in-vehicle component 106 control request provided to the user interface 400. As an example, the vehicle component interface application 118 may detect a user interface interaction to one of the controls 306 of the graphical presentation 404, map the interaction to one of the characteristics of the in-vehicle component 106, and use the characteristic UUID from the low-footprint content interface template 120 to manipulate or otherwise control the in-vehicle component 106. As another example, the vehicle component interface application 118 may detect a user interface interaction to one of the controls 306 of the list presentation 304, and use the characteristic UUID from the low-footprint content interface template 120 to manipulate or control the in-vehicle component 106. After operation 622, the process 600 ends.

At 624, the personal device 104 determines whether the low-footprint content interface template 120 is available. For example, the vehicle component interface application 118 may access the storage of the personal device 104 to determine if a low-footprint content interface template 120 associated with the service identifier UUID of the in-vehicle component 106 is available. If so, control passes to operation 630. If not, control passes to operation 626.

At operation 626, and similar to as described with respect to operation 608, the personal device 104 requests connection to the in-vehicle component 106. At operation 628, and similar to as described with respect to operation 610, the personal device 104 acquires the low-footprint interface template 120. After operation 628, control passes to operation 630.

The personal device 104 provides the user interface 300 derived from the low-footprint content interface template 120 at operation 630. An example user interface 300 is described above with respect to FIG. 3. After operation 630, control passes to operation 622.

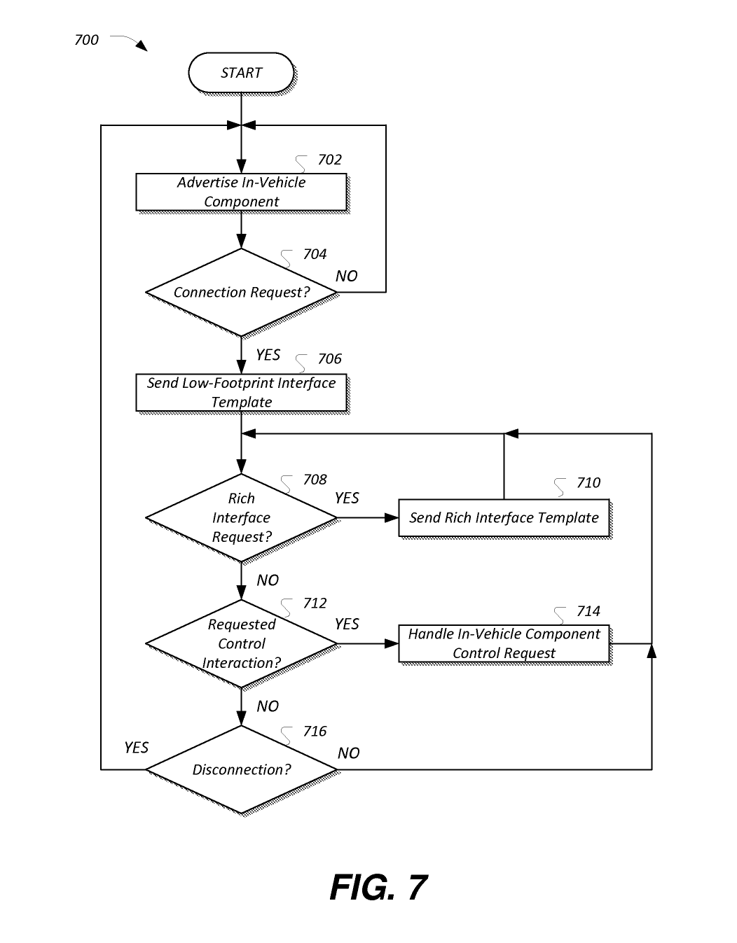

FIG. 7 illustrates an example process 700 for providing interface template information by an in-vehicle component 106. The process 700 may begin at operation 702, in which the in-vehicle component 106 advertises its services. In an example, the advertised information may include a primary service UUID for the in-vehicle component 106.

At 704, the in-vehicle component 106 determines whether a connection request to the in-vehicle component 106 is received. In an example, the in-vehicle component 106 may identify a connection to the in-vehicle component 106 by the personal device 104. In a connection is detected, control passes to operation 706. Otherwise, control returns to operation 702.

At operation 706, the in-vehicle component 106 sends the low-footprint content interface template 120 to the personal device 104. In an example, the low-footprint content interface template 120 may be specified by characteristic UUIDs of the characteristics of the service UUID of the in-vehicle component 106.

At operation 708, the in-vehicle component 106 determines whether a request for the rich content interface template 122 is received. In an example, the in-vehicle component 106 may identify whether a request to communicate the rich content interface template 122 to the personal device 104 is received. If such a request is received, control passes to operation 710 to send the rich content interface template 122 to the personal device 104. Otherwise, control passes to operation 712.

The in-vehicle component 106 determines whether a request for interaction with the in-vehicle component 106 is requested at operation 712. In an example, the in-vehicle component 106 identifies whether a request is received from the personal device 104 identifying a characteristic UUID from the low-footprint content interface template 120 to manipulate or control the in-vehicle component 106. If so, control passes to operation 714 to handle the interaction. Otherwise, control passes to operation 716.

At 716, the in-vehicle component 106 determines whether the personal device 104 is disconnected from the in-vehicle component 106. In an example, the in-vehicle component 106 may receive a request for disconnection from the personal device 104. In another example, the in-vehicle component 106 may determine that no message has been received from the personal device 104 for a predetermined period of time. If the personal device 104 is disconnected from the in-vehicle component 106, control passes to operation 702. Otherwise, control returns to operation 708.

Additionally or alternately, the hybrid user interface approach may be used for help systems for the in-vehicle component 106. For example, help information displayed by the personal device 104 may be built using the same graphics available in the interfaces used to manipulate or control the in-vehicle components 106. This may minimize the amount of information needed to implement both control and help user interfaces, as well as to guarantee a more coherent user experience.

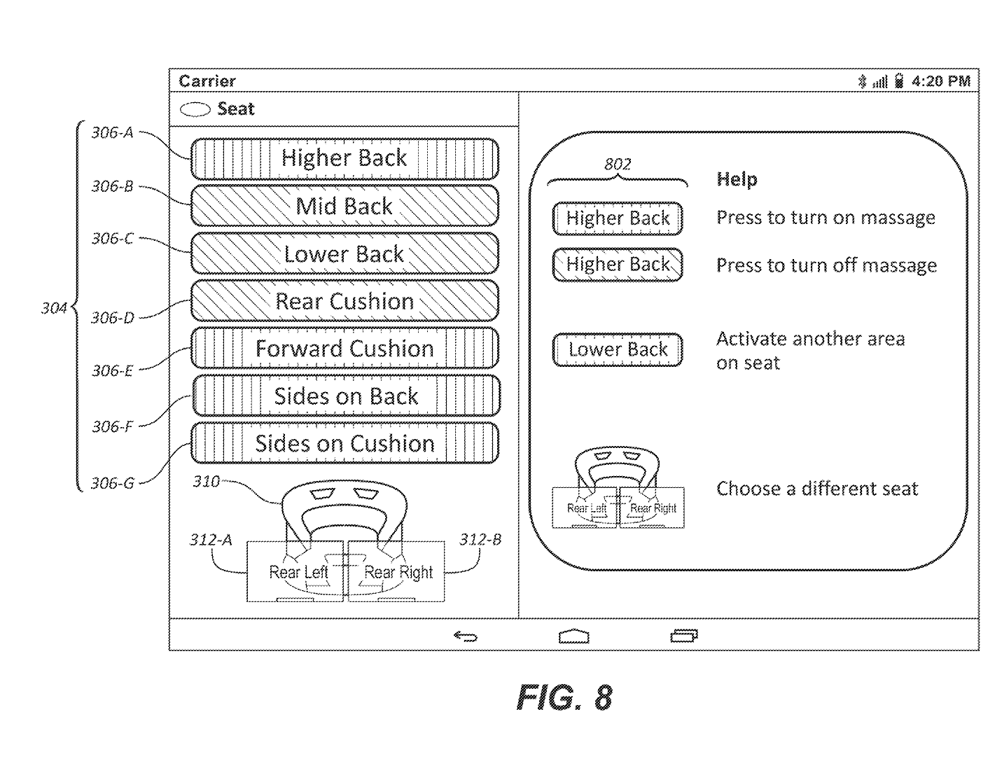

FIG. 8 illustrates an example help user interface 800 derived from a low-footprint interface template 120. As shown, the presentation 304 of selectable controls 306 based on the identified in-vehicle components 106 features is generated utilizing the low-footprint interface template 120. Similarly, the help information 802 descriptions of the identified in-vehicle components 106 features is also generated utilizing the low-footprint interface template 120.

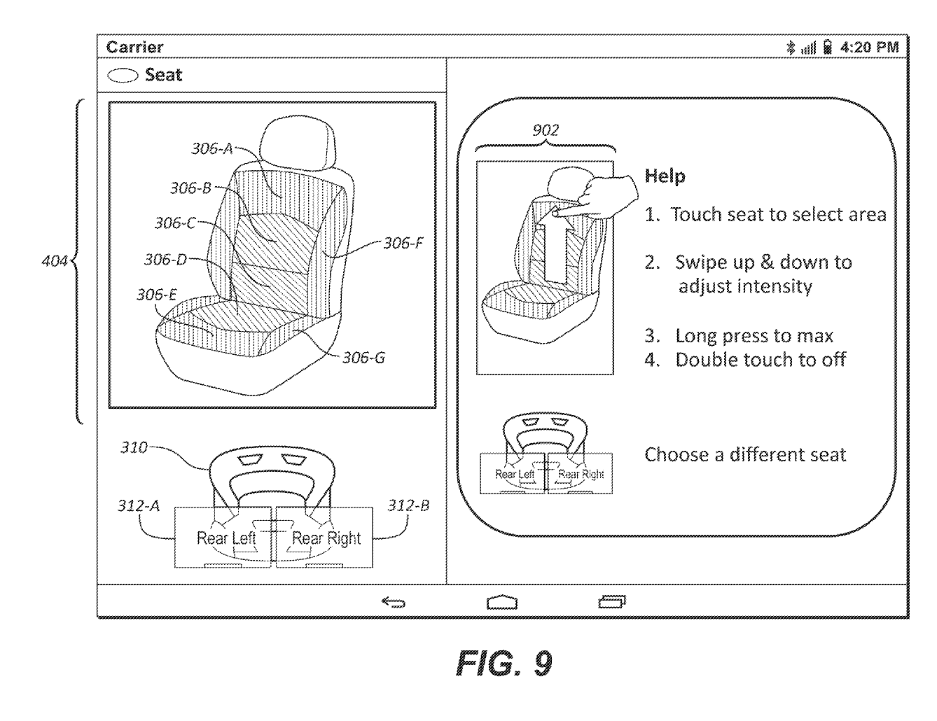

FIG. 9 illustrates an example help user interface 900 derived from a rich content interface template 122. As shown, the presentation 404 of selectable controls 306 is generated utilizing the rich content interface template 122. Similarly, the help information 802 descriptions of the identified in-vehicle components 106 features is also generated utilizing the rich content interface template 122.

In sum, a hybrid user interface approach may two alternative template protocols to render an interface on a personal device 104 for a user to control in-vehicle components 106 in a layered architecture. The low-footprint interface template 120 may have a very small footprint that guarantees system responsiveness and low-cost requirements. The rich content interface template 122 may offer a more graphically-intensive interface, e.g., based on an interface markup language such as XML, JSON, or HTML 5 referencing media content or another technique. Nevertheless, the control of the in-vehicle component 106 may be performed using the information of the low-footprint interface template 120, thereby avoiding use of additional computational power of the in-vehicle component 106 being controlled when the rich content interface template 122 is used for control of the in-vehicle component 106 as compared to when the low-footprint interface template 120 is used for control of the in-vehicle component 106.

Computing devices described herein, such as the personal devices 104 and in-vehicle components 106, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a memory;
a display; and
a processor, programmed to
provide, to the display, a first user interface when the memory includes, for an in-vehicle component, a first interface template including interface markup language with media content and a second interface template generated from feature advertisements of the in-vehicle component; and
provide, to the display, a second user interface when the memory includes the second interface template but not the first interface template.

2. The system of claim 1, wherein the processor is further programmed to generate the second interface template based on an enumeration of characteristics of one or more services of the in-vehicle component exposing the feature advertisements.

3. The system of claim 1, wherein the processor is further programmed to:
store the second interface template to the memory indexed according to a service identifier of the in-vehicle component;
retrieve the second interface template from the memory using the service identifier; and
generate the second user interface from the second interface template.

4. The system of claim 1, wherein the processor is further programmed to download the first interface template from the in-vehicle component.

5. The system of claim 1, wherein the processor is further programmed to:
send, to a server external to a vehicle in which the in-vehicle component is embedded, a request including an identifier of the in-vehicle component; and
download the first interface template, from the server to the memory, responsive to the request.

6. The system of claim 1, wherein the first user interface and the second user interface are descriptive of a help user interface of the in-vehicle component.

7. The system of claim 1, wherein the second user interface includes a listing of controls generated from the feature advertisements of the in-vehicle component, and the first user interface includes a graphical illustration of controls for the in-vehicle component based on the media content and controls locations indicated by the interface markup language, each control of the graphical illustration corresponding to a respective control of the listing of controls.

8. The system of claim 7, wherein the processor is further programmed to:
detect a user interface interaction to one of the controls of the graphical illustration;
map the interaction to a corresponding control of the listing of controls; and
manipulate the in-vehicle component using a characteristic identifier of the corresponding one of the characteristics of the second interface template.

9. A method comprising:
detecting a user interface interaction to a control of a graphical presentation of a rich content interface template including interface markup language and downloaded media content for an in-vehicle component;
mapping the interaction to an identifier of a corresponding characteristic of a low-footprint interface template including identifiers based on an enumeration of characteristics of the in-vehicle component; and
controlling the in-vehicle component using the identifier.

10. The method of claim 9, further comprising:
enumerating characteristics of one or more services indicating features of the in-vehicle component; and
generating the low-footprint interface template based on the enumerating.

11. The method of claim 9, further comprising downloading the rich content interface template from the in-vehicle component.

12. The method of claim 9, further comprising:
sending an identifier of the in-vehicle component to a server; and
downloading the rich content interface template from the server.

13. The method of claim 12, wherein the server is external to a vehicle in which the in-vehicle components are embedded.

14. The method of claim 9, further comprising:
before the rich content interface template is downloaded, displaying a low-footprint user interface using the low-footprint interface template; and
responsive to the rich content interface template being downloaded, switching to displaying a rich content user interface generated using the rich content interface template.

15. The method of claim 14, the low-footprint user interface including a listing of controls, and the rich content user interface including a graphical illustration of the in-vehicle component including controls at selectable locations of the graphical illustration, each control of the graphical illustration corresponding to a respective one of the controls of the listing.

16. A non-transitory computer-readable medium embodying instructions that, when executed by a processor of a personal device, cause the personal device to:
enumerate characteristics of one or more services indicating features of an in-vehicle component;
generate a low-footprint interface template based on the characteristics;
display a low-footprint user interface using the low-footprint interface template;
download a rich content interface template for the in-vehicle component; and
switch to displaying a rich content user interface using the rich content interface template responsive to completion of the download of the rich content interface template.

17. The medium of claim 16, further embodying instructions that, when executed by the processor, cause the personal device to:
send a request including an identifier of the in-vehicle component to a server; and
download the rich content user interface from the server responsive to the request.

18. The medium of claim 16, the low-footprint user interface including a listing of controls, and the rich content user interface including a graphical illustration of the in-vehicle component including controls at selectable locations of the graphical illustration, each control of the graphical illustration corresponding to a respective one of the controls of the listing.

19. The medium of claim 16, further embodying instructions that, when executed by the processor, cause the personal device to:
detect a user interface interaction to a control of the rich content user interface;
map the interaction to an identifier of a corresponding characteristic of the low-footprint interface template; and
manipulate the in-vehicle component using the identifier.

20. The medium of claim 16, wherein the rich content interface template includes a markup format describing the rich content user interface including one or more of extensible markup language (XML), and hypertext markup language (HTML).
